(19) United States
(12) Patent Application Publication
(10) Pub. No.: US 2011/0010389 A1
(43) Pub. Date: Jan. 13, 2011

(54) METHOD FOR PRESENTING INFORMATION TO AN ADVISOR AT A CALL CENTER

(75) Inventors: SALLY D. SHAFFER, LIVONIA, MI (US); MICHAEL M. FAHIE, FARMINGTON HILLS, MI (US); ELLEN P. AJERSCH, LA SALLE (CA)

Correspondence Address: INGRASSIA FISHER & LORENZ, P.C. (GM), 7010 E. COCHISE ROAD, SCOTTSDALE, AZ, 85253, US

(73) Assignee: GENERAL MOTORS CORPORATION, DETROIT, MI (US)

(21) Appl. No.: 12/501,194

(22) Filed: Jul. 10, 2009

(51) Int. Cl. G06F 17/30

(52) U.S. Cl. 707/770; 707/822; 707/706; 707/709

(57) ABSTRACT

A method is disclosed herein for presenting information to an advisor at a call center. The method includes, but is not limited to, displaying basic vehicle information to the advisor regarding a remotely located vehicle. The method further includes presenting the advisor with an option to obtain additional vehicle information regarding the remotely located vehicle. The method further includes automatically obtaining the additional vehicle information from multiple data storage components in response to a request made by the advisor to obtain the additional vehicle information. The method also includes displaying the additional vehicle information to the advisor.

### TECHNICAL FIELD

The technical field generally relates to a method for providing an advisor at a call center with information about a remotely located vehicle, and more particularly relates to a method for providing an advisor with information from a plurality of data storage components.

### BACKGROUND

Some vehicles in the marketplace are configured to enable a driver to engage in voice communications with a remotely located call center that is configured to provide a variety of vehicle related services and assistance to the driver. To facilitate this, these vehicles are equipped with a telematics unit, described in detail below, that permits the driver to contact a call center over existing wireless communication networks and to engage in voice communications with a human advisor who is trained to provide the services and assistance.

When contacting the call center, the telematics unit electronically transmits identifying information including a vehicle identification number (hereinafter “VIN”) and a station identifier (hereinafter “STID”) which is a unique electronic identifier embedded within the telematics unit. Upon receipt of the VIN and the STID, computer and communications systems located at the call center access basic vehicle information stored at the call center regarding the remotely located vehicle and display that basic vehicle information to the human advisor. Such information includes the account number associated with the remotely located vehicle as well as the amount of time remaining in the account holder's subscription.

In one known example, additional vehicle information such as information relating to the telematics unit (e.g. which generation the telematics unit is, which software version the telematics unit is running, and the capabilities of the telematics unit) and/or information relating to the vehicle itself (e.g. the vehicle's make, model and year of manufacture, options, equipment, trim level, and configuration) are not automatically presented to the human advisor in response to the call center's receipt of the VIN and the STID. To obtain such additional vehicle information, the human advisor must actively interrogate a plurality of different databases and/or data storage components. One or more of these separately queried databases/data storage components may be operated by entities other than the entity operating the call center.

Because such additional vehicle information may not be maintained by the call center, obtaining the additional vehicle information may necessitate accessing remote computer systems using various communication networks. This can be a time consuming and/or labor intensive task that may divert the human advisor's attention away from the driver's request for assistance. This, in turn, could distract and/or delay the human advisor's response to a driver's request for assistance.

Accordingly, it is desirable to reduce the human advisor's work load and to allow the advisor to more rapidly attend to the driver calling for assistance) by assisting the advisor in obtaining the additional vehicle information. In addition, it is desirable to automate the process for obtaining such information. Furthermore, other desirable features and characteristics will become apparent from the subsequent detailed description and the appended claims, taken in conjunction with the accompanying drawings and the foregoing technical field and background.

### SUMMARY

A method is provided for presenting information to an advisor at a call center. In a first, non-limiting example, the method includes, but is not limited to, displaying basic vehicle information to the advisor regarding a remotely located vehicle. The method further includes the step of presenting the advisor with an option to obtain additional vehicle information regarding the remotely located vehicle. If the advisor elects to obtain the additional vehicle information, then the method further includes the step of automatically obtaining the additional vehicle information from an unaffiliated data storage component. The method also includes the step of displaying the additional vehicle information to the advisor.

In a second non-limiting example, the method includes, but is not limited to, receiving an electronic transmission from a telematics unit mounted on a remotely located vehicle, the electronic transmission containing vehicle identifying information. The method further includes displaying basic vehicle information regarding the remotely located vehicle to the advisor in response receiving the electronic transmission. The method further includes presenting the advisor with an option to obtain additional vehicle information regarding the remotely located vehicle. If the advisor elects to obtain the additional vehicle information, then the method further includes automatically obtaining the additional vehicle information from an unaffiliated data storage component. The method further includes displaying the additional vehicle information regarding the remotely located vehicle to the advisor.

In a third, non-limiting example, the method includes, but is not limited to, receiving an electronic transmission at the call center from a telematics unit mounted on a remotely located vehicle, the electronic transmission containing vehicle identifying information. The method further includes automatically obtaining basic vehicle information regarding the remotely located vehicle from a data storage component associated with the call center. The method further includes displaying the basic vehicle information to the advisor. The method further includes presenting the advisor with an option to obtain additional vehicle information regarding the remotely located vehicle. If the advisor elects to obtain the additional vehicle information, then the method further includes automatically obtaining the additional vehicle information from a plurality of unaffiliated data storage components, at least one of which is associated with an entity other than the call center, in response to a request made by the advisor to obtain the additional vehicle information. The method further includes displaying the additional vehicle information to the advisor.

### DESCRIPTION OF THE DRAWINGS

One or more examples will hereinafter be described in conjunction with the following drawing figures, wherein like numerals denote like elements, and

FIG. 1 is a schematic view illustrating a non-limiting example of a system configured to carry out the methods disclosed herein;

FIG. 2 is a schematic view illustrating a non-limiting example of an arrangement of data storage components suitable for use with the system of FIG. 1;

FIG. 3 is a representation of a non-limiting example of a display presented to an advisor at a call center containing the additional vehicle information; and

FIG. 4 is a flow chart illustrating a non-limiting example of a method disclosed herein.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

Various, non-limiting examples of a method for presenting information to an advisor at a call center are disclosed herein. In one non-limiting example, a call center is configured to receive communications from a remotely located vehicle. The call center houses a human advisor (hereinafter “advisor”) and a variety of computer systems and communication networks, discussed in detail below, that enable the advisor to engage in both internal communications within the call center and external communications with computer systems operated by entities other than the call center.

The advisor works at a work station equipped with an electronic processing device such as a personal computer, and visual display component, such as a computer monitor. The electronic processing device is configured to receive and run software applications and to engage in electronic communications with other electronic processing devices and computer components using the communication networks provided by the call center. Such other electronic devices and computer components may be located at the call center or may be located remotely from the call center.

The call center receives an electronically transmitted request for assistance (hereinafter, the “request for assistance”) from a remotely located vehicle. The request for assistance contains the VIN and the STID for the remotely located vehicle and is provided to an electronic processing device.

When the VIN, the STID, and the request for assistance is received at the electronic processing device, software running on the electronic processing device controls the electronic processing device to automatically send a request using the communication networks associated with the call center to a local data storage component for basic vehicle information regarding the remotely located vehicle. The local data storage component may be located at the call center, may be dedicated exclusively to storing basic vehicle information for the purpose of servicing requests for assistance, and/or may otherwise be associated with the call center.

The local data storage component sends the basic vehicle information to the electronic processing device in response to the request. When the basic vehicle information is received at the electronic processing device, the software running on the electronic processing device controls the electronic processing device to display the basic vehicle information to the advisor using the display component.

In addition, the software controls the electronic processing device to display to the advisor an option to obtain additional vehicle information. In one non-limiting example, the option may be presented to the advisor by displaying an icon on a graphical user interface displayed to the advisor on the display component. The icon may appear in the same window as the basic vehicle information or may be presented in a separate window. In another non-limiting example, the electronic processing device may be running voice recognition software and the option may be presented to the advisor audibly and the advisor may respond verbally.

If the advisor elects to obtain the additional vehicle information, then the software running on the electronic processing device controls the electronic processing device to automatically send an additional request or a plurality of additional requests using the communication networks provided by the call center to a respective one or more unaffiliated data storage components that store, maintain or otherwise have access to additional vehicle information relating to the remotely located vehicle. As used herein, the term “unaffiliated” used together with the term “data storage component” means a data storage component under the control of an entity other than the call center and/or a data storage component under the control of the call center but which differs from the data storage component containing the basic vehicle information. Communication with the unaffiliated data storage components may be accomplished in any suitable manner including, but not limited to, use of the internet, use of one or more intranets, and use of various wireless and wired communication networks.

In one non-limiting example, the tasking of the unaffiliated data storage components to supply the additional vehicle information may occur serially, i.e., the electronic processing device transmits a first additional request to a first unaffiliated data storage component and then awaits the response before transmitting a second additional request to a second unaffiliated data storage component. In another non-limiting example, the tasking of the unaffiliated data storage components may occur substantially simultaneously, i.e., the electronic processing device transmits the first additional request to a first unaffiliated data storage component and then transmits a second additional request to a second unaffiliated data storage component without waiting for a response from the first unaffiliated data storage component. Such substantially simultaneous tasking of unaffiliated data storage components can accelerate the process of procuring the additional vehicle information.

When the additional vehicle information is received by the electronic processing device at the advisor's work station, the software running on the electronic processing device will control the electronic processing device to display the additional vehicle information to the advisor using the display component. The additional vehicle information may be presented in the same window as the basic vehicle information or, alternatively, may be displayed in a separate window. The additional vehicle information may relate to the vehicle itself, such as the year, make, model, options, specifications and configuration of the remotely located vehicle (to the extent this information is not already included in the call center data bases). The additional vehicle information may also relate to the telematics unit attached to the remotely located vehicle. The additional vehicle information may also include an image of a vehicle of the same make, model, color, and configuration as the remotely located vehicle. The additional vehicle information may also include any other information needed by the advisor to facilitate his ability to assist the driver of the remotely located vehicle. In this manner, the additional vehicle information can be automatically obtained without advisor involvement leaving the advisor free to interact with the driver of the remotely located vehicle.

A greater understanding of the methods disclosed herein may be obtained through a review of the accompanying illustrations and the related detailed description below.

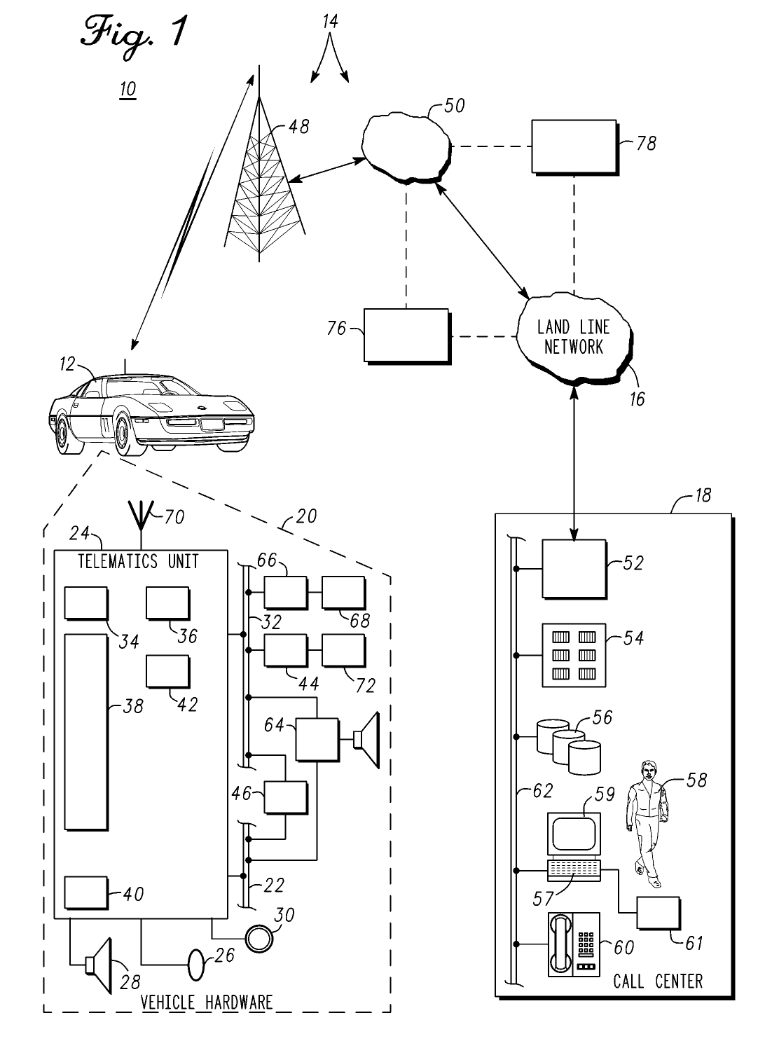

With reference to FIG. 1, there is shown a non-limiting example of a communication system 10 that may be employed to perform the methods disclosed herein for presenting information to an advisor at a call center disclosed herein. The communication system generally includes a vehicle 12, a wireless carrier system 14, a land network 16 and a call center 18. It should be appreciated that although communication system 10 is described in some detail, other systems not shown here could also be used to employ the present method.

Vehicle 12 may be any type of mobile vehicle such as a motorcycle, car, truck, recreational vehicle (RV), boat, plane, etc., and is equipped with suitable hardware and software that enables it to communicate over system 10. Some of the vehicle hardware 20 is shown generally in FIG. 1 including a telematics unit 24, a microphone 26, a speaker 28 and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO, SAE, and/or IEEE standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70 and a navigation unit containing a GPS chipset/component 42. In one example, the wireless modem 36 includes a computer program and/or set of software routines executing within processing device 38.

The telematics unit 24 provides various services including: turn-by-turn directions and other navigation-related services provided in conjunction with the GPS based chipset/component 42; airbag deployment notification and other emergency or roadside assistance-related services provided in connection with various crash and or collision sensor interface modules 66 and crash sensors 68 located throughout the vehicle; and/or infotainment-related services where music, internet web pages, movies, television programs, videogames and/or other content are downloaded by an infotainment center 46 operatively connected to the telematics unit 24 via vehicle bus 32 and audio bus 22. In one example, downloaded content is stored for current or later playback.

The above-listed services are by no means an exhaustive list of all the capabilities of telematics unit 24, but are simply an illustration of some of the services that the telematics unit may be capable of offering. It is anticipated that telematics unit 24 will include a number of known components in addition to those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and a wireless modem 36 for data transmission. In order to enable successful data transmission over the voice channel, wireless modem 36 applies some type of encoding or modulation to convert the digital data so that it can communicate through a vocoder or speech codec incorporated in the cellular chipset/component 34. Any suitable encoding or modulation technique that provides an acceptable data rate and bit error can be used with the present method. Dual mode antenna 70 services the GPS chipset/component and the cellular chipset/component.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons or controls 30 for enabling a vehicle occupant to activate or engage one or more components of vehicle hardware 20. For example, one of the buttons and/or controls 30 can be an electronic pushbutton used to initiate voice communication with call center 18, whether it be a live advisor (hereinafter “advisor 58”) or an automated call response system. In another example, one of the buttons and/or controls 30 can be used to initiate emergency services.

The vehicle audio component 64 is operatively connected to the vehicle bus 32 and the audio bus 22. The vehicle audio component 64 receives analog information, rendering it as sound, via the audio bus 22. Digital information is received via the vehicle bus 32. The vehicle audio component 64 provides AM and FM radio, CD, DVD, and multimedia functionality independent of the infotainment center 46. Vehicle audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The crash sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Examples vehicle sensors include but are not limited to gyroscopes, accelerometers, magnetometers, emission detection and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones and connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, live advisors (hereinafter “advisor 58), as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either the advisor 58 or an automated response system, and data transmissions are passed on to a modem or other piece of telecommunication/computer equipment 60 for demodulation and further signal processing. The telecommunication/computer equipment 60 (modem) may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data.

Each advisor 58 works at a workstation and can access the components and equipment available at call center 18 using an electronic processing device 57 and a display component 59. Software application 61 is loaded into electronic processing device 57 and, when running, controls electronic processing device 57. In other examples, software application 61 may be loaded into server 54 which may act as an electronic processing device that remotely controls electronic processing device 57.

Software application 61 may be configured to facilitate the ability of advisor 58 to provide assistance to a driver of vehicle 12. When a request for assistance (which includes the VIN and the STID of vehicle 12) is transmitted by vehicle 12, and received by call center 18, the request is forwarded to the server 54 or the electronic processing device 57. Software application 61 controls the server 54 or electronic processing device 57 to send a request over bus 62 to data bases 56 to obtain the basic vehicle information, which is then displayed to advisor 58 on display component 59.

The basic vehicle information may include information relating to the account associated with vehicle 12 such as its account number and the period of time remaining until the subscription lapses. Other items included with the basic vehicle information may include, but are not limited to, the name of the primary account holder, the owner of vehicle 12, basic vehicle information and the length of time the account has been active.

Software application 61 will also control electronic processing device 57 to present the advisor with an option to obtain additional vehicle information relating to vehicle 12. The option may be presented in the form of an icon which may be selected, clicked, or otherwise actuated by advisor 58. In another example, the option may be presented audibly through an interactive voice recognition system. Alternatively, the option may be presented to the advisor through a combination of visual and audible signals, or in any other manner effective to make advisor 58 aware of the opportunity to obtain additional vehicle information. In still other examples, no option will be presented to advisor 58. Rather, software application 61 may, instead, automatically send out a plurality of requests to various unaffiliated data storage components to obtain the additional vehicle information after the basic vehicle information has been obtained or at the same time that the basic vehicle information is being obtained.

When the advisor elects the option to obtain the additional vehicle information, software application 61 controls the server 54 or electronic processing device 57 to send out a plurality of requests to various unaffiliated data storage components to obtain the additional vehicle information. As used herein, the term “additional vehicle information” refers to information comprising a compilation of discrete items of information supplied by the various unaffiliated data storage components. The plurality of requests may contain the VIN and the STID and any other items of information known about vehicle 12 or about the account associated with vehicle 12 which may be needed to obtain the additional vehicle information from the unaffiliated data storage components.

Some portions of the additional vehicle information may be available locally at call center 18. For example, some of the additional vehicle information may be stored on data bases housed at call center 18 on data bases 56, on other data bases housed at call center 18, on server 54, or on other data storage components accessible through bus 62.

Other portions of the additional vehicle information may be stored on data storage components located external to call center 18. This is illustrated in FIG. 1 in the form of a first unaffiliated data storage component 76 and a second unaffiliated data storage component 78, both of which are located outside of, and disconnected from, call center 18.

First unaffiliated data storage component 76 may be located at facilities owned and/or operated by the manufacturer of vehicle 12, by suppliers to the manufacturer, or by any other entity contributing to the manufacture of vehicle 12 or otherwise associated with the manufacturer of vehicle 12. Second unaffiliated data storage component 78 may be located at facilities owned and/or operated by the manufacturer of telematics unit 24, by suppliers to the manufacturer of telematics unit 24, or by any other entity contributing to the manufacturer of telematics unit 24 or otherwise associated with the manufacture of telematics unit 24.

Additional unaffiliated data storage components storing any and all types of information relating to vehicle 12 may also be interrogated by the server 54 or electronic processing device 57. For example, unaffiliated data storage components operated by vehicle dealerships, and automotive service centers.

Electronic processing device 57 or the server 54 may communicate with the various unaffiliated data storage components utilizing any suitable communication system. For instance, communications may occur using an intranet, the internet, a wired telecommunications network, a wireless telecommunications network, a satellite communications network and/or any other type of communication system effective to convey the interrogation transmitted by the server 54 or electronic processing device 57 and the additional vehicle information transmitted by an interrogated unaffiliated data storage component back to the server 54 or electronic processing device 57.

First unaffiliated data storage component 76 and Second unaffiliated data storage component 78 may be any suitable device and/or component for storing and/or maintaining electronic data, including, but not limited to, data bases, hard drives, flash drives, memory sticks, tape drives, magnetic tape, floppy discs, CDs, DVDs or any other device or medium configured to store and/or access data.

In FIG. 1, first and second unaffiliated data storage components 76, 78 are illustrated as being connected to wireless carrier system 14 and to land network 16. The connection is illustrated using phantom lines to indicate that the connection can either be between the unaffiliated data storage components and wireless carrier system 14 or between the unaffiliated data storage components and land network 16. In some implementations, the unaffiliated data storage components may be connected to both wireless carrier system 14 and to land network 16. Other combinations and permutations as well as the inclusion of additional or fewer unaffiliated data storage components are also possible.

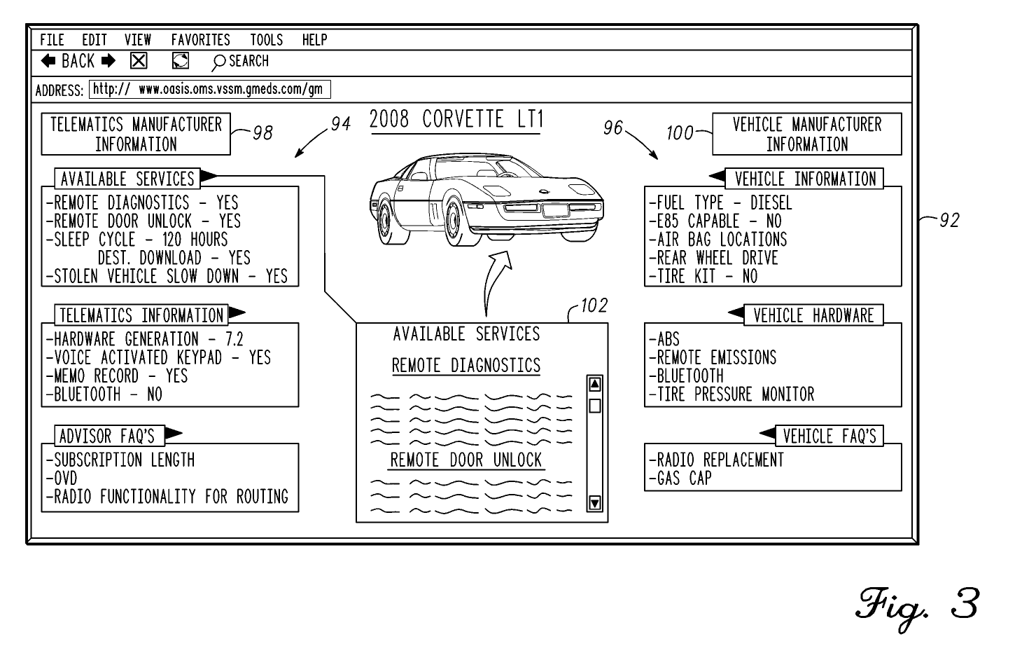

When the additional vehicle information is received by the server 54 or electronic processing device 57, it may be stored temporarily in RAM or some other non-permanent memory medium and software application 61 controls electronic processing device 57 to present the additional vehicle information to advisor 58 on display component 59. An example of such a display is illustrated in FIG. 3, discussed below.

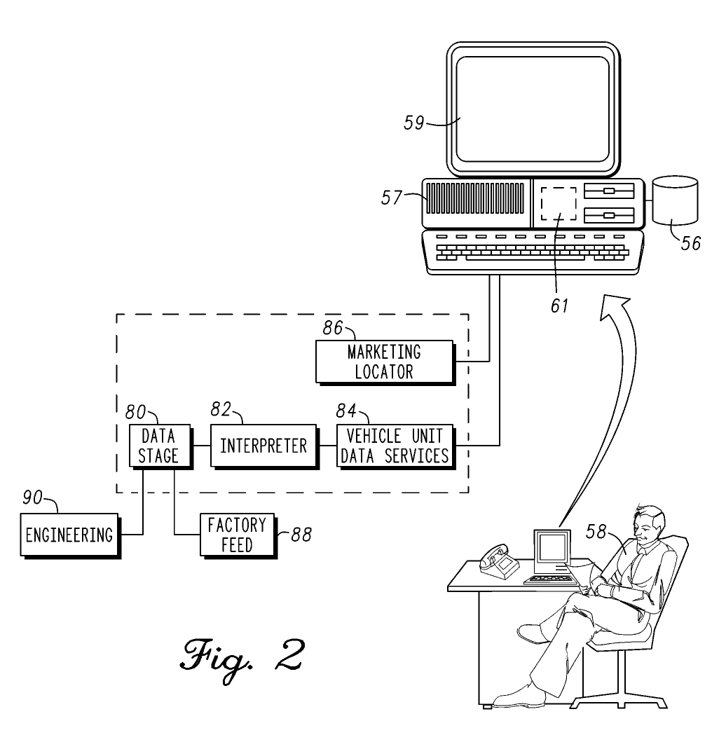

With respect to FIG. 2, a non-limiting example of a system architecture configured to implement the method discussed above is schematically illustrated. In the illustrated example, the unaffiliated data storage components are contained within a box drawn with phantom lines and include a data stage component 80, an interpreter component 82, a vehicle unit data services component 84, and a marketing locator service component 86. In other examples, a greater or lesser number of unaffiliated data storage components may be included.

Data stage component 80 may be any type of computer component configured to store electronic data. In one non-limiting example, data stage component 80 may comprise a hard drive. Data stage component 80 stores VIN numbers as well as codes, such as Regular Production Options Codes, that relate to vehicle configurations and options. For example, data stage component 80 may store vehicle make and model information and may also store information relating to the features and options available on each make and model. This information may be provided to data stage component 80 by a manufacturing facility 88 where vehicle 12 or a component of vehicle 12 was assembled and/or manufactured. This information may also be provided to data stage component 80 by an engineering facility 90 where vehicle 12, or a component of vehicle 12 was designed and developed. Other sources may also contribute information to data stage component 80.

Interpreter component 82 may be any type of computer component configured to store and/or to process electronic data. In one non-limiting example, interpreter component 82 may comprise a server. Interpreter component 82 stores one or more sets of rules which are used to interpret the vehicle features and configuration data that are provided by data stage component 80 to determine the capabilities and/or limitations of telematics unit 24. For example, there may be a rule that holds that vehicles that lack an anti-lock breaking system are not capable of receiving navigation guidance from call center 18. Neither the VIN nor the codes stored in data stage component 80 will include information regarding whether vehicle 12 is able to receive navigation assistance from call center 18. However, the VIN and/or the other codes stored in data stage component 80 will provide information relating to whether vehicle 12 is equipped with anti-lock breaks. Interpreter component 82 interprets this data to provide advisor 58 information about vehicle 12's ability to receive navigation services. The one or more sets of rules may be written/provided by a manufacturer of telematics unit 24 and/or by a manufacturer of a component of telematics unit 24.

Vehicle unit data services component 84 may be any type of computer component configured to store and/or to process electronic data. In one non-limiting example, vehicle unit data services component 84 may comprise a server. Vehicle unit data services component 84 serves to provide the VIN or the STID when only one or the other is given. Vehicle unit data services component 84 also provides information regarding the software loaded onto telematics unit 24 such as its version and its associated capabilities to receive services available from call center 18. This information may be provided by a manufacturer of telematics unit 24 and/or by a manufacturer of a component of telematics unit 24.

Marketing locator component 86 may be any type of computer component configured to store and/or to process electronic data. In one non-limiting example, marketing locator component 86 may comprise a server. Marketing locator component 86 provides information to advisor 58 regarding the appearance of vehicle 12. Marketing locator component 86 stores and maintains URL's for vehicle images. Marketing locator component 86 will forward an image of vehicle 12 to advisor 58. In some examples, the image will be the precise make, model, configuration and color of vehicle 12. Marketing locator component 86 may also provide text identifying the make, model and color of vehicle 12. Marketing locator component may receive data from the manufacturer of vehicle 12 or from an entity responsible for marketing vehicle 12.

With respect to FIG. 3, a non-limiting example of the different types of information that may be included in the additional vehicle information is illustrated. In FIG. 3, the additional vehicle information is displayed on display component 59 in a window that resembles an internet web page (hereinafter, “page 92”). On page 92, the additional vehicle information is presented in two columns, a first column 94 and a second column 96. Each column has a header. First header 98, entitled “Telematics Manufacturer Information”, signifies that the information, links, pull-down menus, etc . . . disposed below first header 98 relate to the telematics unit 24 and/or the services provided by call center 18 that telematics unit 24 is configured to support. In other examples, the actual commercial name of the manufacturer of telematics unit 24 or the name under which call center 18 operates may be presented in first header 98.

Second header 100, entitled “Vehicle Manufacturer Information” signifies that the information, links, pull-down menus, etc . . . disposed below second header 100 relate to the manufacturer of vehicle 12. In other examples, the actual commercial name of the vehicle manufacturer or the name under which the vehicle manufacturer operates may be presented in second header 100.

Below first and second header 98, 100 are arranged sub-categories of information, each having its own header and including a link. In approximately the center of page 92 is a window 102 having a scroll bar that provides an expanded view of a selected sub-category. Window 102 also provides additional information pertaining to the various sub-categories. In this manner, advisor 58 may select any of the sub-categories under either of the first and second headers 98 and 100 to provide greater assistance to drivers seeking assistance.

Disposed above window 102 is an image 104 of a vehicle. As discussed above, in some examples, image 104 is an image of a vehicle having the same make, model, model year, trim level, options package and color as vehicle 12. In other examples, a stock image may be presented of a vehicle having only the same make and model as vehicle 12. In window 106, disposed above image 104, the model, model year, and make of vehicle 12 is presented in text.

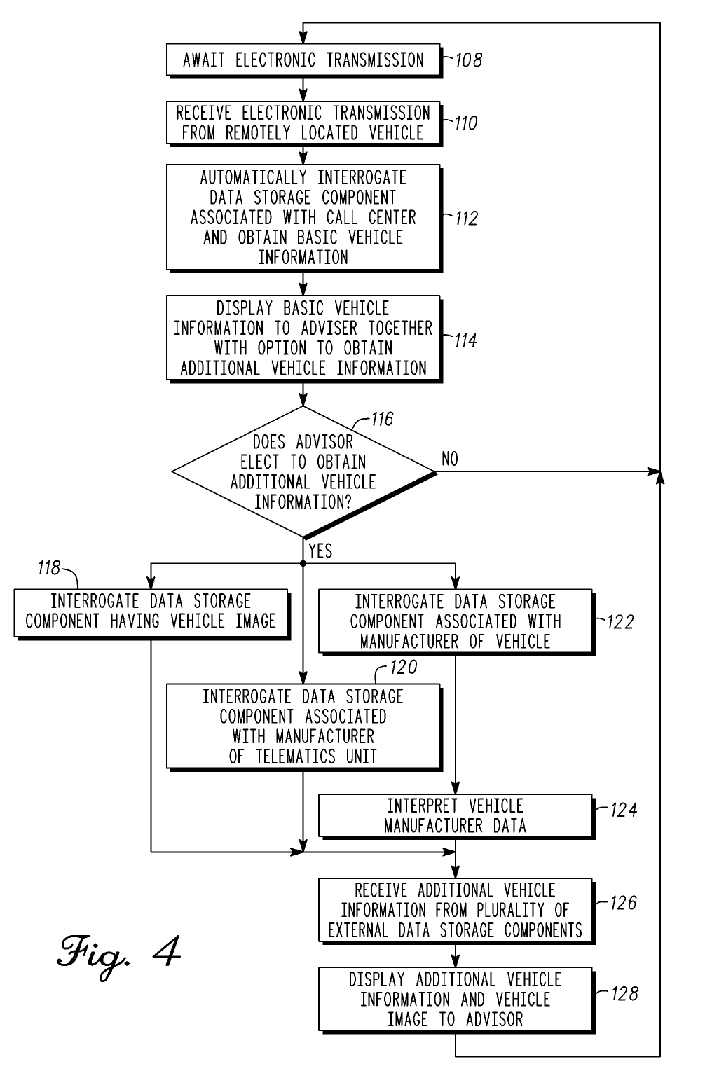

With respect to FIG. 4, a flow chart is presented illustrating the various steps of a non-limiting example of the methods discussed above for presenting information to an advisor at a call center. At block 108, call center 18 and advisor 58 await a request for assistance from a driver of vehicle 12 equipped with telematics unit 24. When the driver depresses button and/or controls 30, it causes telematics unit 24 to wirelessly transmit an electronic request for assistance through dual mode antenna 70. The electronic request for assistance contains the VIN and STID for vehicle 12.

In some examples, the request for assistance is transmitted by vehicle 12 via cellular telecommunications. Using cellular chipset/component 34, telematics unit 24 transmits a wireless cellular signal compatible with wireless carrier system 14. Wireless carrier system 14 may then forward the request for assistance to land network 16 which, in turn, forwards the request to call center 18. At block 110, the request for assistance is received at call center 18. The request for assistance enters call center 18 through switch 52 and is routed to the server 54 or electronic processing device 57 located at a work station where advisor 58 is seated.

At block 112, the server 54 or electronic processing device 57 will automatically interrogate a data storage component associated with call center 18 to obtain basic vehicle information. To accomplish this step, software application 61 controls the server 54 or electronic processing device 57 to transmit an interrogation prompt along bus 62 to data base 56 where the basic vehicle information is stored. Database 56 responds by forwarding the basic vehicle information related to vehicle 12 to electronic processing device 57 along bus 62.

At block 114, the basic vehicle information is displayed to advisor 58 together with an option to obtain additional vehicle information. To accomplish this step, software application 61 controls electronic processing device 57 to display the basic vehicle information on display component 59. Software application 61 is further configured to control electronic processing device 57 to cause an icon to appear on display component 59. It should be understood that presentations other than icons could also be presented, for example, a fillable field or a check box or a button may be presented to name only a few. In systems that are text based as opposed to those that use a graphical user interface, text may appear requesting advisor 58 to respond with text.

At block 116, advisor 58 has a choice between seeking additional vehicle information or not seeking additional vehicle information. If advisor 58 elects not to obtain the additional vehicle information, then the method returns to block 108 to await the next request for assistance.

If the examiner elects to obtain additional vehicle information, then software application 61 controls the server 54 or electronic processing device 57 to send out requests to a plurality of unaffiliated data storage components to obtain the additional vehicle information. In the illustrated example, the electronic processing device substantially simultaneously tasks the unaffiliated data storage components to provide the additional vehicle information. In other examples, electronic processing device could task the unaffiliated data storage components serially.

The request for additional vehicle information is transmitted from the server 54 or electronic processing device 57, along bus 62 to switch 52 where it is directed out of call center 18 and on to land network 16 and/or wireless carrier system 14. Land network 16 and/or wireless carrier system 14 then directs the request to unaffiliated data storage components, such as first and second unaffiliated data storage component 76, 78, as well as to other unaffiliated data storage components.

At block 118, an unaffiliated data storage component where vehicle images are stored is tasked to supply an image of a vehicle similar or substantially identical to vehicle 12. At block 120, an unaffiliated data storage component associated with the manufacture of telematics unit 24 is tasked to supply information pertaining to telematics unit 24 and/or the software running on telematics unit 24.

At block 122, an unaffiliated data storage component associated with the vehicle manufacturer is tasked to supply information pertaining to vehicle 12. At block 124, the information pertaining to vehicle 12 is interpreted to provide additional information about telematics unit 24, the availability of services provided by call center 18, and/or additional information pertaining to vehicle 12. It should be understood that the tasks described in blocks 118, 120 and 122 are exemplary in nature and are not intended to be limiting and that other types of information may be obtained from other unaffiliated data storage components not included in FIG. 4.

The various unaffiliated data storage components discussed above send the additional vehicle information back to electronic processing device 57 along wireless carrier system 14 and/or land network 16, through switch 52, along bus 62 to electronic processing device 57. This is reflected in block 126 where it is indicated that the additional vehicle information is received from the plurality of unaffiliated data storage components.

Once electronic processing device 57 received the additional vehicle information, software application 61 controls electronic processing device 57 to display the additional vehicle information on display component 59. The additional vehicle information may be presented to the advisor in the manner shown in FIG. 3 or in any other suitable manner. This step is illustrated at block 128. Once this step is complete, the method returns to block 108 to await the next request for assistance.

While at least one non-limiting example has been presented in the foregoing detailed description, it should be appreciated that a vast number of variations exist. It should also be appreciated that the example or examples described above are merely exemplary, and are not intended to limit the scope, applicability, or configuration in any way. Rather, the foregoing detailed description will provide those skilled in the art with a convenient road map for implementing the example or examples. It should be understood that various changes can be made in the function and arrangement of elements without departing from the scope as set forth in the appended claims and the legal equivalents thereof.

What is claimed is:

1. A method for presenting information to an advisor at a call center, the method comprising:
displaying basic vehicle information to the advisor regarding a remotely located vehicle;
presenting the advisor with an option to obtain additional vehicle information regarding the remotely located vehicle;
automatically obtaining the additional vehicle information from an unaffiliated data storage component in response to a request made by the advisor to obtain the additional vehicle information; and
displaying the additional vehicle information to the advisor.

2. The method of claim 1 wherein the step of automatically obtaining the additional vehicle information comprises interrogating at least one data storage component associated with an entity other than the call center.

3. The method of claim 1 wherein the step of automatically obtaining the additional vehicle information comprises substantially simultaneously tasking a plurality of the unaffiliated data storage component to provide the additional vehicle information.

4. The method of claim 1 further comprising the step of interpreting data provided by the unaffiliated data storage component.

5. The method of claim 4 wherein the step of interpreting data comprises applying a rule to at least some of the data provided by the unaffiliated data storage component to derive at least a portion of the additional vehicle information.

6. The method of claim 1 wherein the step of presenting the advisor with an option to obtain the additional vehicle information comprises displaying an icon on a graphical user interface.

7. The method of claim 1 wherein the step of automatically obtaining the additional vehicle information comprises:
automatically obtaining information relating to a telematics unit mounted to the remotely located vehicle from a data storage component associated with a manufacturer of the telematics unit; and
automatically obtaining information relating the remotely located vehicle from a data storage component associated with a manufacturer of the remotely located vehicle.

8. The method of claim 1 wherein the step of automatically obtaining the additional vehicle information comprises obtaining an image of the remotely located vehicle and wherein the step of displaying the additional vehicle information comprises displaying the image of the remotely located vehicle.

9. A method for presenting vehicle information to an advisor at a call center, the method comprising:
receiving an electronic transmission from a telematics unit mounted on a remotely located vehicle, the electronic transmission containing vehicle identifying information;
displaying basic vehicle information regarding the remotely located vehicle to the advisor in response receiving the electronic transmission;
presenting the advisor with an option to obtain additional vehicle information regarding the remotely located vehicle;
automatically obtaining the additional vehicle information from an unaffiliated data storage component in response to a request made by the advisor to obtain the additional vehicle information; and
displaying the additional vehicle information regarding the remotely located vehicle to the advisor.

10. The method of claim 9 wherein the step of automatically obtaining the additional vehicle information comprises interrogating at least one data storage component associated with an entity other than the call center.

11. The method of claim 9 wherein the step of automatically obtaining the additional vehicle information comprises:
automatically obtaining information relating to the telematics unit from a data storage component associated with a manufacturer of the telematics unit; and
automatically obtaining information relating the remotely located vehicle from a data storage component associated with a manufacturer of the remotely located vehicle.

12. The method of claim 9 further comprising the step of interpreting data provided by the unaffiliated data storage component.

13. The method of claim 12 wherein the step of interpreting data comprises applying a rule to at least some of the data provided by the unaffiliated data storage component to derive at least a portion of the additional vehicle information.

14. The method of claim 9 wherein the step of presenting the advisor with an option to obtain the additional vehicle information comprises displaying an icon on a graphical user interface.

15. The method of claim 9 wherein the step of automatically obtaining the additional vehicle information comprises obtaining an image of the remotely located vehicle and wherein the step of displaying the additional vehicle information comprises displaying the image of the remotely located vehicle.

16. A method for presenting vehicle information to an advisor at a call center, the method comprising:
receiving an electronic transmission at the call center from a telematics unit mounted on a remotely located vehicle, the electronic transmission containing vehicle identifying information;
automatically obtaining basic vehicle information regarding the remotely located vehicle from a data storage component associated with the call center;
displaying the basic vehicle information to the advisor;
presenting the advisor with an option to obtain additional vehicle information regarding the remotely located vehicle;
automatically obtaining the additional vehicle information from a plurality of data storage components, at least one of which is associated with an entity other than the call center, in response to a request made by the advisor to obtain the additional vehicle information; and
displaying the additional vehicle information to the advisor.

17. The method of claim 16 wherein the step of automatically obtaining the additional vehicle information comprises:
automatically obtaining information relating to the telematics unit from a data storage component associated with a manufacturer of the telematics unit; and
automatically obtaining information relating the remotely located vehicle from a data storage component associated with a manufacturer of the remotely located vehicle.

18. The method of claim 16 further comprising the step of interpreting data provided by the plurality of data storage components.

19. The method of claim 18 wherein the step of interpreting data comprises applying a rule to at least some of the data provided by the plurality of data storage components to derive at least a portion of the additional vehicle information.

20. The method of claim 16 wherein the step of automatically obtaining the additional vehicle information comprises obtaining an image of the remotely located vehicle and wherein the step of displaying the additional vehicle information comprises displaying the image of the remotely located vehicle.
